(19) United States
(12) Patent Application Publication
(10) Pub. No.: US 2006/0090591 A1
(43) Pub. Date: May 4, 2006

(54) Transmission housing

(76) Inventor: Michael Graeve, Weinstadt-Schnait (DE)

Correspondence Address: KLAUS J. BACH, 4407 TWIN OAKS DRIVE, MURRYSVILLE, PA, 15668, US

(21) Appl. No.: 11/284,441

(22) Filed: Nov. 21, 2005

Related U.S. Application Data
(63) Continuation-in-part of application No. PCT/EP04/03340, filed on Mar. 30, 2004.

(30) Foreign Application Priority Data
May 22, 2003 (DE) 103 23 074.2

(51) Int. Cl. F16H 57/02

(52) U.S. Cl. 74/607

(57) ABSTRACT

In a transmission housing for motor vehicles, which consists of magnesium or a magnesium alloy and is provided with reinforcement ribs having rounded base sections, transverse ribs which extend in the rounded base sections of the housing ribs and the transmission housing wall is relatively thin and provided on the outside at least partially with a waffle-patterned surface reinforcing the housing wall thereby saving weight and providing in the manufacturing process for good casting flow conditions and cooling properties.

This is a Continuation-in-Part application of International Application PCT/EP2004 filed Mar. 30, 2004 and claiming the priority of German Application 103 23 074.4 filed May 22, 2003.

### BACKGROUND OF THE INVENTION

The invention relates to a transmission housing, in particular for motor vehicles, made from a light metal or light metal alloy. The transmission housing has a mounting flange with holes, a plastic oil sump connected to the mounting flange by means of aluminum spacers and aluminum bolts and is provided with rounded sections and reinforcement ribs arranged on the outside of the transmission housing.

In order to reduce the weight and hence the fuel consumption and exhaust emissions of motor vehicles, steel is increasingly replaced by light metals or light metal alloys. This gives rise to new problems, however, because these light metals or light metal alloys are difficult to cast, for example, and often have unfavorable cooling behavior because sticking points and drawing points occur and the ductility is poor, whilst the tendency to shrinkage and the tendency to notching on the other hand are particularly pronounced.

The German journal DE-Z Konstruktion 43 (1991) pages 365-370 (“Design of reinforcement ribs and holes in transmission housings” by B. Wender and S. Lecong), which includes instructions for the design of reinforcement ribs and bores in a transmission housing for increasing the rigidity of a commercial vehicle transmission housing of pressure die-cast aluminum discloses a transmission housing of the generic type.

U.S. patent specification U.S. Pat. No. 3,263,521 further discloses a transmission housing, which is made from magnesium or a magnesium alloy and which, among other things, has reinforcement ribs and rounded sections.

It is the object of the present invention to provide a transmission housing made from a light metal or light metal alloy which is capable of saving yet more weight compared to the state of the art and in which the flow and cooling properties in the manufacturing process are also improved.

### SUMMARY OF THE INVENTION

In a transmission housing for motor vehicles, which consists of magnesium or a magnesium alloy and is provided with reinforcement ribs having rounded base sections, transverse ribs which extend in the rounded base sections of the housing ribs and the transmission housing wall is relatively thin and provided on the outside at least partially with a waffle-patterned surface reinforcing the housing wall thereby saving weight and providing in the manufacturing process for good casting flow conditions and cooling properties.

Like the other features specified, the waffle pattern on the surface of the transmission housing wall serves to improve the flow properties in the manufacturing process, to obtain a more uniform solidification behavior after casting and to increase the rigidity of the wall. The waffle pattern furthermore results in a larger surface, thereby improving the dissipation of heat generated inside the transmission housing during vehicle operation.

According to a further embodiment of the invention, the holes are made as blind holes. Depressions and other unfavorable points on the transmission housing, in or on which dirt, moisture and salts can collect, and which form electrolytes that may cause corrosion, are effectively avoided at the outset due to the smooth housing surface provided thereby. Any surface coating of the transmission housing, chemical and/or metallurgical finishing treatment or sealing measures to the surface of the transmission housing, in the form of a plastic coating for example, are unnecessary. The making of blind holes furthermore largely prevents any tendency to notching.

Preferably, the transmission housing has rounded sections with radii in excess of 4 mm. This design is conducive to the use of magnesium as it significantly improve the flow properties during casting and furthermore effectively suppresses the formation of notch cracks.

The transmission housing is preferably made from the magnesium alloys MgAl2Si (AS21HP) or MgAl4Si (AS41HP). These materials (HP herein indicates High Purity) are highly corrosion-resistant magnesium alloys having a high creep resistance and high rigidity; the use of MgAl2Si (AS21HP) or MgAl4Si (AS41HP) permits a more thin-walled transmission housing which results in further material and cost savings. It also improves the vibration behavior and reduces the flexure of the transmission housing.

The invention will become more readily apparent from the following description of a particular embodiment thereof with reference to the accompanying drawings.

### BRIEF DESCRIPTION OF THE DRAWINGS

FIG. 1 is a sectional, schematic representation of a transmission housing having mounting flanges and an oil pan mounted thereto,

FIG. 2 is a view of the transmission housing from beneath and

FIG. 3 is a side view of the transmission housing.

### DETAILED DESCRIPTION OF A PARTICULAR EMBODIMENT

The invention is particularly suitable for a transmission housing made from magnesium or a magnesium alloy for an automatic transmission of a motor vehicle.

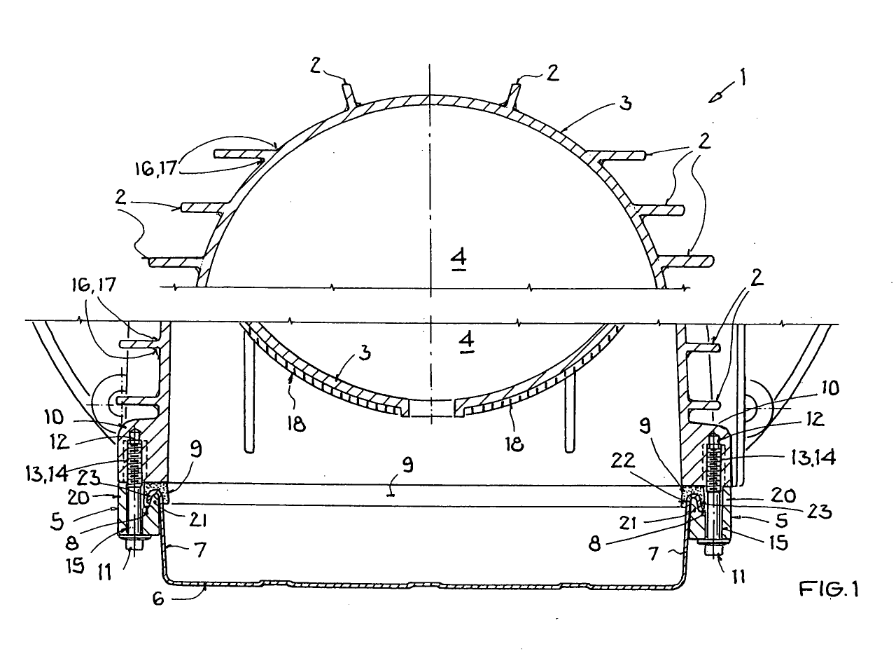

FIG. 1 shows a transmission housing 1, which is manufactured from magnesium or a magnesium alloy by a casting process. Examples of suitable materials for the transmission housing 1 are the magnesium alloys MgAl2Si (AS21HP) or MgAl4Si (AS41HP), distinguishing characteristics of which are a high creep resistance of up to 150° and a high corrosion resistance. Reinforcement ribs or flow ribs 2 on its outside 3 increase the rigidity of the transmission housing 1 and also improve the flow conditions for the fluid molten material in the casting process. The interior space 4 enclosed by the transmission housing 1 serves to accommodate a transmission, in particular an automatic transmission for a motor vehicle.

An oil pan 6, usually made from plastics and having a side wall 7, is fixed to the transmission housing 1 by means of one or more spacers 5. The spacers 5 preferably consist of aluminum or an aluminum alloy and each have a recess 8 between an outer leg 20 and an inner leg 21, in order to accommodate the oil pan 6. The inner leg 21 is shortened, in particular being approximately half the length of the outer leg 20, and forms a clamping structure.

In cross section, each spacer 5 is of U-shaped design and has a hole 15 in the outer leg 20 of the U-shaped structure. A fastening screw presses the free end of the outer leg 20, where necessary in sealing relationship, against a support flange 10.

The upper end portion of the side wall 7 of the oil pan 6 is U-shaped and includes an inner leg 22 and an outer leg 23. With the outer side leg 23 of the U-shaped area, the side wall 7 extends into the recess 8 in the spacer 5. The openings of the U-shaped cross sections of the spacer 5 and the oil pan 6 are aligned and open in opposite directions.

The spacers 5 are mounted by means of mounting screws or bolts 11 to mounting flanges 10 integrally formed with the transmission housing 1. For this purpose holes 12 are disposed in the mounting flanges 10 and according to the invention these holes 12 are blind holes. A thread 13 is tapped into the blind holes 12 or a threaded sleeve 14, preferably made of aluminum is inserted. For reasons of weight the mounting bolts 11 preferably consist of aluminum or an aluminum alloy, and are guided by the hole 15 in the spacer 10 and screwed to the thread 13 or the threaded sleeve 14.

A mat-shaped sealing element 9, with a U-shaped cross section fully or at least partially covers the end face of the side leg 23, the side leg 22 and the base part of the U-shaped end area of the oil pan 6, and is arranged between the spacer 5 and the U-shaped end area of the oil pan side wall 7. When the mounting bolt 11 is tightened, the sealing element 9 is clamped on the one hand between the end face of the side leg 23 and the base part of the spacer 5, and on the other between the base leg of the U-shaped end area of the oil pan 6 and the mounting flange 10.

In order to improve the flow conditions for the casting material during manufacturing and to prevent the formation of notch cracks, rounded sections with radii 16 are formed with a size R4 or greater. For improved heat dissipation during casting it is moreover advantageous if small transverse ribs 17, with a height of 0.8 mm for example, extend in the rounded section radii area 16.

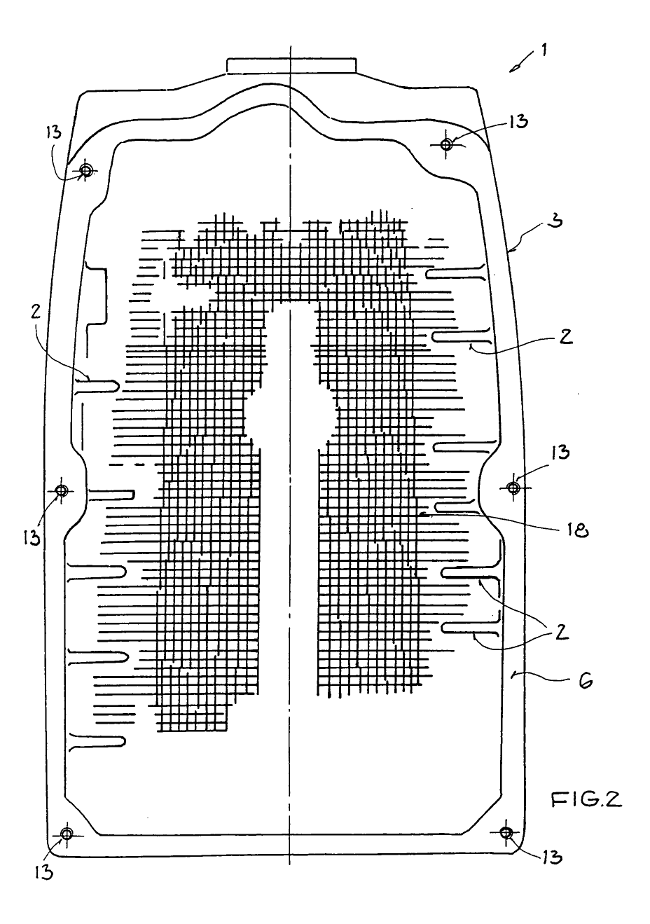

It can be seen from FIG. 2 that the underside of the transmission housing 1 has, at least in parts, a waffle patterned surface 18, the grid interval of the waffle pattern 18 being 5 mm, for example, and its elevations being 0.8 mm, for example. In conjunction with the reinforcement ribs 2 and the transverse ribs 17 (FIG. 1) this significantly improves the heat transfer both during casting in the manufacturing process and subsequently during operation.

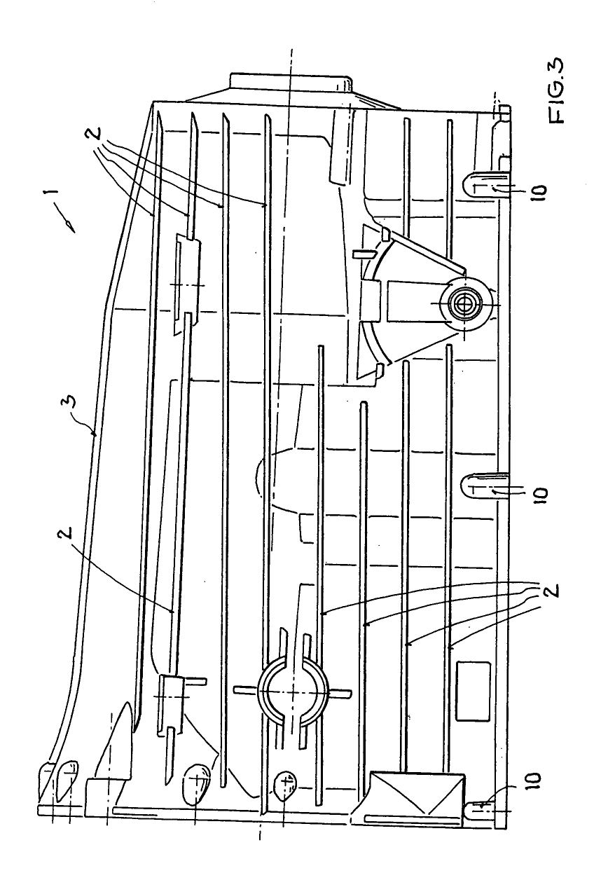

FIG. 3 again clearly shows the reinforcement ribs 2 in the lateral area of the transmission housing 1, which preferably extend in an axial direction and which in addition to the improved heat transfer also provide for greater rigidity, as has already been described.

What is claimed is:

1. A transmission housing (1) for motor vehicles, said transmission housing (1) consisting of a light metal or light metal alloy and having a mounting flange (10) with holes (12) formed therein, a plastic oil pan (6) mounted to the mounting flange (10) by means of aluminum spacers (5) and aluminum bolts (11), said transmission housing (1) having reinforcement ribs (2) on the outside (3) thereof with rounded base sections (16) of relatively small radii, and transverse ribs (17) disposed in the rounded base sections (16), the outside (3) of the transmission housing (1) being provided at least partially with a waffle-patterned surface (18).

2. The transmission housing as claimed in claim 1, wherein the transverse ribs (17) project by 0.8 mm.

3. The transmission housing as claimed in claim 1, wherein the holes (12) are blind holes.

4. The transmission housing as claimed in claim 3, wherein threads (13) are tapped into the blind holes (12).

5. The transmission housing as claimed in claim 3, wherein threaded sleeves (14) are inserted into the blind holes (12).

6. The transmission housing as claimed in claim 1, wherein the rounded sections (16) at the base of the ribs (17) are formed with radii in R4 size or greater.

7. The transmission housing as claimed in claim 1, wherein the light metal or the light metal alloy is magnesium or a magnesium alloy.

8. The transmission housing as claimed in claim 7, wherein the transmission housing consists of one of the magnesium alloy MgAl2Si (AS21HP) and MgAl4Si (AS41HP).

9. The transmission housing as claimed in claim 1, wherein a sealing element (9) is disposed between the spacers (5) and the oil pan (6).
